(19) United States
(12) Patent Application Publication
(10) Pub. No.: US 2018/0128460 A1
(43) Pub. Date: May 10, 2018

(54) CYLINDRICAL HOUSING FOR MODULAR LIGHTING SYSTEM

(71) Applicant: ROBERT A. SONNEMAN, MAMARONECK, NY (US)

(72) Inventor: ROBERT A. SONNEMAN, MAMARONECK, NY (US)

(21) Appl. No.: 15/585,278

(22) Filed: May 3, 2017

Related U.S. Application Data
(63) Continuation-in-part of application No. 29/587,102, filed on Dec. 9, 2016, now Pat. No. D793000.
(60) Provisional application No. 62/419,505, filed on Nov. 9, 2016.

(51) Int. Cl. F21V 21/14; F21S 8/06; F21V 21/104; F21V 21/35; F21S 8/04

(52) U.S. Cl. CPC F21V 21/14; F21S 8/063; F21S 8/046; F21V 21/35; F21V 21/104

(57) ABSTRACT

In a modular lighting system, a pendant is provided that is hung from and gets power from a power bar. In one version, the pendant includes a pendant body that is attached directly to and depends from the power bar. The pendant can be provided with one light source, or two light sources directed in opposite directions. In another version, the pendant is attached to the power bar by a hanger and has connectors allowing the pendant to rotate about a horizontal axis. The hanger can optionally include a member attached to the power bar and configured to allow two rods and the pendant depending from the rods to rotate about a vertical axis.

### RELATED APPLICATIONS

This application claims priority to provisional application Ser. No. 62/419,505 filed Nov. 9, 2016 and U.S. application Ser. No. 29/587,102 filed Dec. 9, 2016 and incorporated herein in its entirety.

### BACKGROUND OF THE INVENTION

### A. Field of Invention

This invention pertains to a modular system having components that can be assembled to form multi-level lights of various sizes, shapes and configurations. The main elements are canopies supporting the system, hangers, power bars, and pendants, preferably including LED bulbs. In this application a cylindrical housing is described that can be used to attach various lighting fixtures directly to a power bar within the system.

### B. Description of the Prior Art

Designing lighting for a space has always been an interesting challenge because the lighting equipment has to meet utilitarian, technical and esthetic needs. Thus, any such endeavor is successful only if combining technical, architectural and artistic skills.

Several different types of ceiling lights are presently available, including surface mounted lights, recessed lights and hanging lights. The present invention pertains to hanging lights.

In previously filed patent applications, a modular lighting system is disclosed in which hangers are provided for hanging power bars from ceilings or other architectural surfaces.

### SUMMARY OF THE INVENTION

Briefly, a modular lighting system for providing light in a space includes canopies connectable to a power source; a plurality of horizontal bars; a plurality of hangers, including a first set of hangers supporting bars from said canopy and a second set of hangers, each said hangers including a first end disposed between and engaging said bar segment. The system further includes a plurality of pendants supported by the second set of hangers from the bars. The hangers and bars cooperate to provide electric power to said pendants from said canopy.

Preferably, each bar includes two bar segments facing each other and being made of a non-conductive material. Conductive rails are provided on the inner surface of each bar segment. The hangers include a base configured to form an interference fit with the bar segments. In one embodiment, the hangers are made of conductive rods or cables that are in electrical contact with the rails through the respective bases.

In one embodiment, the bars are straight or linear. In another embodiment, the bars are circular or have some other curvilinear shape.

The bars preferably extend horizontally, however different bars are disposed at different heights and are supported from one or more canopies or straight from a ceiling by hangers of various configurations or cables.

Preferably, at least one of the canopies is connected to a line voltage and transformer is used to step down the line voltage to a lower voltage such as 24 vac which is then distributed to the pendants through the hangers and bars.

The pendants include light emitting elements such as LEDs, electronic circuitry for driving the LEDs, and are preferably shaped for heat dissipation. Since the LEDs have a long life, they are not replaceable but instead the whole pendant is replaced as needed.

These various elements are combined in many different ways resulting in a virtually infinite number of configurations. One class of configuration may include several bars disposed in a vertical plane. In another class of configurations, several bars extend at different angles in one plane, and are joined at a common point. Another class of configurations may include a combination of the first to classes. Another class of configurations may include several bars disposed at different heights or tiers, some bars being perpendicular to other bars.

In the present applications, a novel housing is provided that can be used to attach lights directly to one of the power bars.

In one embodiment; a pendant is provided that includes a bar engaging member having two horizontal channels with a separating wall sized and shaped to engage the power bar with the two segments disposed in said channel. The bar engaging member further includes electrical clips arranged to form an interference fit and an electrical connection within the rails within the power bar. The bar engaging member further includes a first flat surface; and; a first pendant body attached to the first flat surface and a light source receiving power through said electrical clips and generating light.

Preferably, the first flat surface is formed with two pins and the first pendant body is formed with two openings, the first pendant body being attached by coupling the first pendant body and the bar engaging member with the pins entering said openings and twisting said pendant body and said bar engaging member with respect to each other. The pins provide electrical current to said light source. The bar engaging member and the first pendant body have matching cross-sections. For instance, the bar engaging member and the first pendant body are cylindrical.

In one embodiment, a second pendant body substantially identical to said first pendant body is provided; with the pendant bodies having light sources pointing in different direction.

In another embodiment; a pendant is provided with a hanger having a power bar engaging member selectively engaging the power bar and two vertical rods, each rod being electrically connected to a respective rail of the power bar; and a pendant body having first and second connectors. Each said connector is configured to receive a respective end of one of said vertical rods. The pendant body further includes a light source generating light when receiving current from the power bar through the rods and said connectors.

The connectors are arranged and constructed to rotate within the pendant body to allow the pendant body to rotate about a horizontal axis with respect to the rods while remaining connected to the rods.

In one embodiment, the power bar engaging member is configured to allow said rods to rotate about a vertical axis with respect to the power bar.

In one embodiment, the power bar engaging member is formed with two horizontal channels with a separating wall sized and shaped to engage the power bar with the two segments disposed in said channels. The bar engaging member further includes electrical clips arranged to form an interference fit and an electrical connection with the rails within the power bar, the rods being electrically connected to the rails of the power bar through said clips.

The hanger includes a lower body selectively attached to the power bar engaging member with the power bar disposed within the channels. The rods depend on said lower body.

### DESCRIPTION OF THE DRAWINGS

FIG. 1 shows an orthogonal view of a modular lighting system.

FIG. 2 shows an orthogonal view of another modular lighting system.

FIGS. 3A-3K shows details of a power bar used in the system if FIG. 1 or FIG. 2.

FIGS. 4A-4J show details of hangers used in the system of FIG. 1 or FIG. 2.

FIGS. 5A-5E show a pendant for the modular lighting systems that is constructed and arranged so that it can be mounted directly on a power bar;

FIGS. 5F-5O show various configurations using the basic pendant structure shown in FIGS. 5A-5E; and

FIGS. 6A-6G show pendants similar to the ones in FIGS. 5A-5E but configured for selective rotation about a horizontal and/or vertical axes.

### DETAILED DESCRIPTION OF THE INVENTION

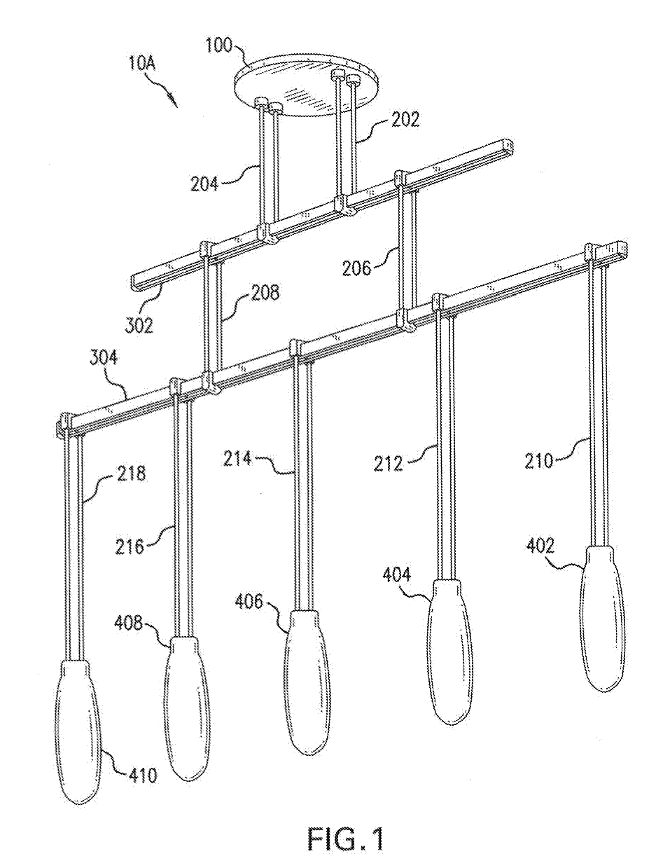

FIG. 1 show the elements of modular lighting systems constructed in accordance with this invention. Generally speaking, each system includes one or more canopies 100, a plurality of hangers 200, a plurality of power bars 300 and a plurality of pendants 400. In addition, some systems may also include optional connectors 500.

Unless otherwise noted, all the hangers and all power bars consist of two interconnected elements.

In the FIG. 1, system 10 includes a canopy 100 that supports the system from a ceiling or other similar architectural member in a conventional manner. In this case, the canopy 100 also provides power to the system. Other, more complicated systems may have several canopies provided for support and only some or only one canopy may also provide power. Canopy 100 includes a conventional power supply connected to standard AC lines for providing power to the LED tubes in the pendants as discussed below. The power supply is hidden.

Two hangers 202, 204 extend downwardly from the canopy. In one embodiment, each hanger discussed hereinafter consists of two solid bars or rods. These hangers are termed the power feed hangers. In an alternate embodiment the hangers are replaced by multi-strand twisted steel cables.

In FIG. 1 the hangers 202, 204 are used to support a power bar 302. Two hangers 206, 208 are used to support a second power bar 304. These hangers are termed the power bar hangers.

Another set of hangers 210-218 are used to support a plurality of pendants 402-410. These hangers are termed pendant hangers. The pendants 402-410 preferably include LED bulbs running on 24 VAC

Preferably, one of the power feed hangers, e.g., hanger 202 has its two hanger segments connected to a transformer disposed within the canopy 100. The transformer steps down the line voltage from a standard power line to 24 VAC for the pendants 402-410. The other hanger 204 may be electrically floating. The power from the hanger 202 flows through the bar segments of bar 302, hanger 206, bar 304 and hangers 210-212 to the pendants. Thus, in this embodiment, only some of the pendants carry power but all the power bars do.

Two different kinds of power bar hangers are provided: parallel hangers for hanging one power bar beneath another, wherein the two power bars extend in parallel. Perpendicular hangers are used to support one power bar from the other wherein the two bars are running perpendicular two each other as described in more detail below.

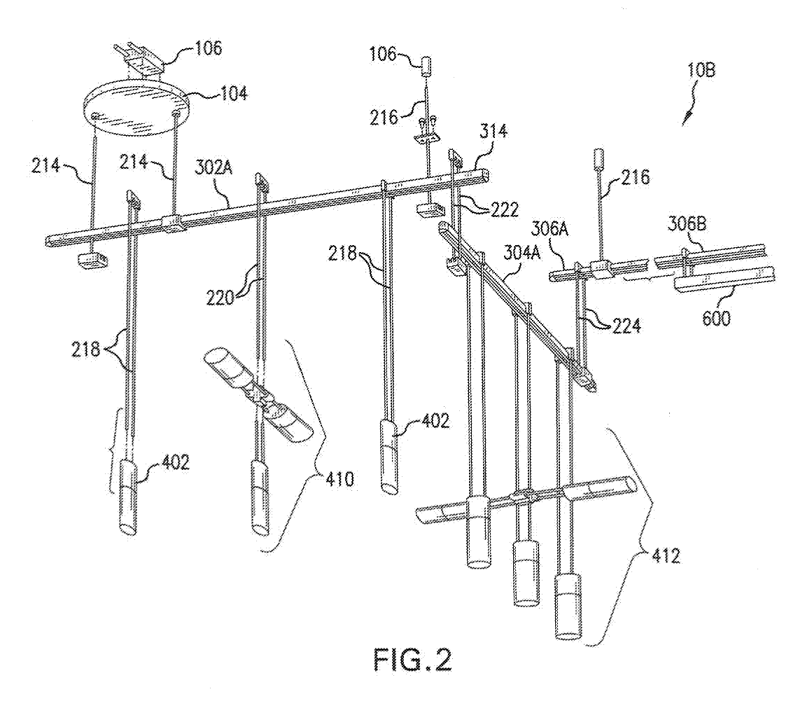

FIG. 2 shows yet another system 10B. This system 10B includes a canopy 104 with a transformer 106. Attached to the canopy 104 is a first bar 302A using two hangers 214. As opposed to the hangers discussed previously, hangers 214 have a single extended element, such as a rod. Each of the hangers 214 provides power to one of the elements of bar 302A. However because the bar 302A is not centered below the canopy 104 but extends in one direction away therefrom. Another hanger 216, which may be referred to as a ceiling hanger, is used to support a distal end 314 of bar 302. At its top, hanger 216 is attached to a sleeve 106 secured to the ceiling in a conventional manner.

Hangers 218 are used to attach respective pendants 402 from bus 302. Another hanger 220 is used to support a cluster of pendants 410.

A second bar 304A is also provided. This bar 304A is supported at one end by a hanger 222 from bar 302A. This hanger 222 also provides power to bar 304A. A third bar 306 is also provided that is supported from the ceiling by ceiling hangers 216 (only one such ceiling hanger is being shown for the sake of clarity). Bar 306 supports the second end of bar 304A and receives power from said bus 304 through hanger 224. Each of the bars 302A, 304A, 306 can be used to hang pendants of various sizes and shapes and arranged in different configurations as desired.

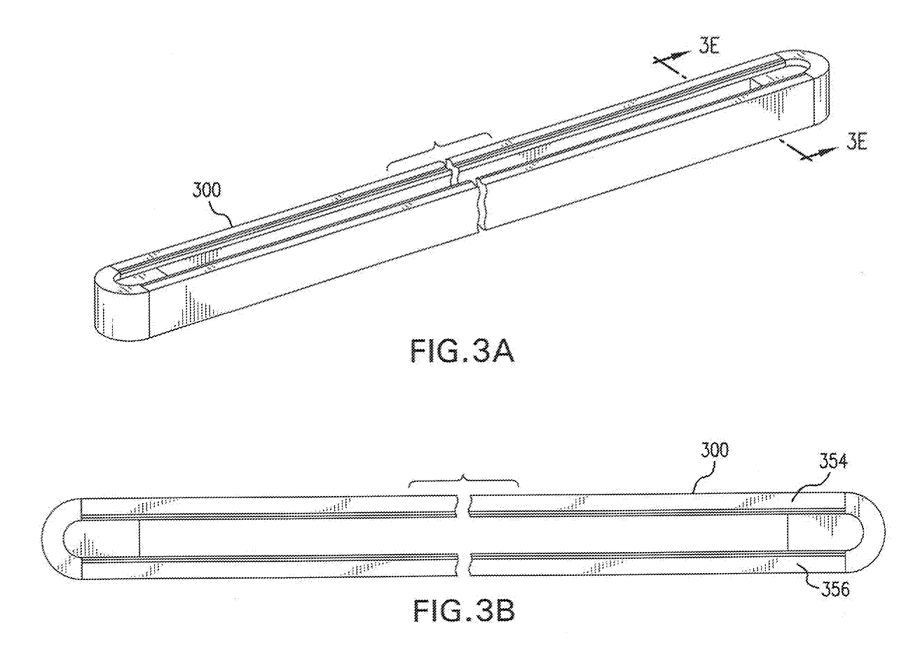

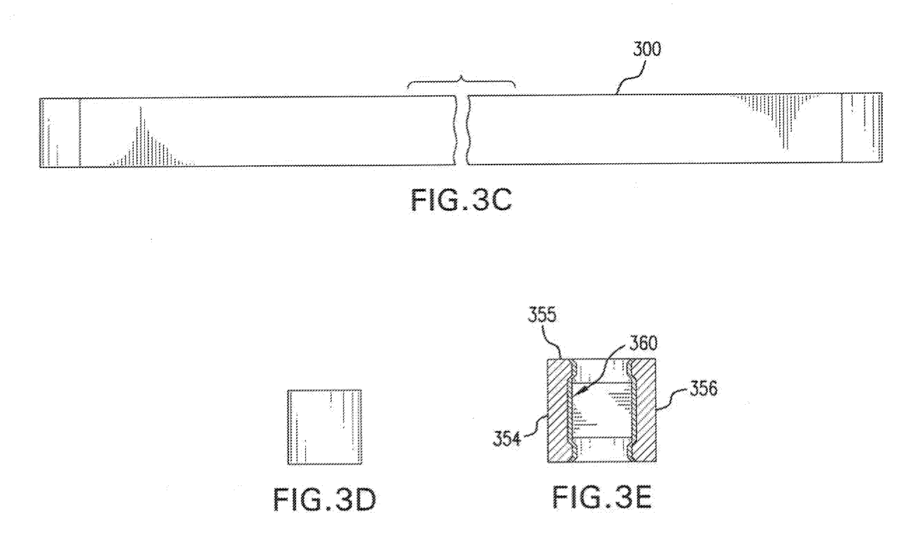

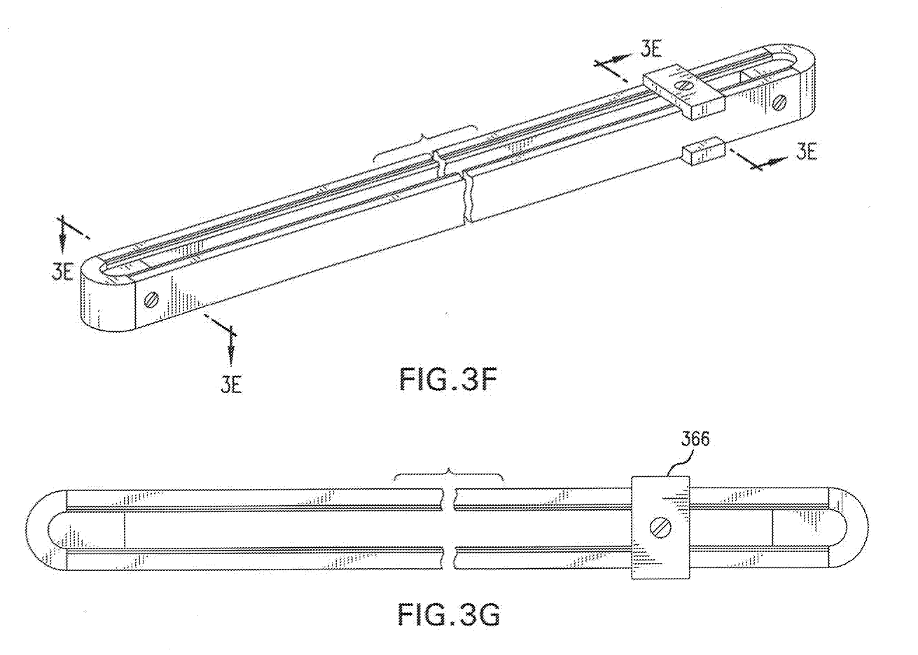

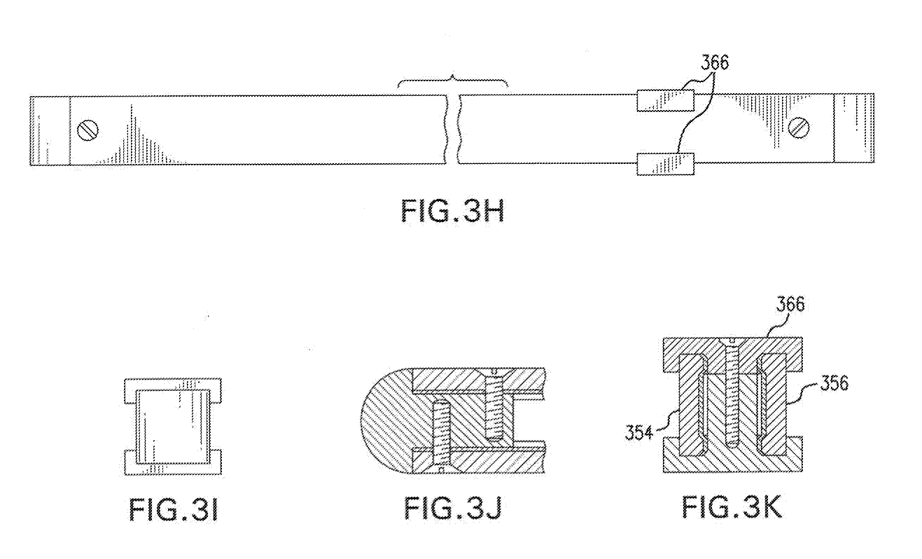

Details of a generic bar 300 are shown in FIGS. 3A-3K. Unless otherwise noted, all the bars discussed here have the same configuration. In this Figure, bar 300 is shown as being straight however, it can be circular ellipsoid or can have other geometric shape. The bar 300 includes two identical longitudinal segments 352, 354 facing each other. A cross-sectional view of segment 354 is seen in FIG. 3B. Segment 354 is formed of a C-shaped main body 355 made of a non-conductive material, such as a plastic material that is light weight but strong so that it can support various pendants, other bars, etc. Imbedded in this main body 355 is a rail 356 made of a light weight conductive material such as aluminum. Preferably rail 356 is formed with a rectangular channel 360. The two segments 352, 354 are joined together at the two ends by end connectors 362. The connectors 362 are attached to the bars by conventional means, such as screws 364, by an adhesive or other means.

Preferably, the two segments 352, 354 have inner surfaces spaced at a nominal distance d throughout the length of the bar 300. The bar 300 is made in standard lengths ranging from to 12 to 48 inches. For very long bars, for example in excess of 24 inches, a spacer 366 is placed between the segments. The spacer 366 may be held in place by screws or other means.

There are several different types of bar hangers are provided: hangers for supporting bars from canopies, hangers for supporting bars from ceilings (without a power connection), hangers for supporting one bar from another bar and hangers for supporting pendants. All these hangers have must be able to interface with a bar at least at one end as described below.

There are two types bar-to-bar hangers: parallel hangers for connecting two parallel bars and perpendicular hangers connecting two bars running perpendicular two each other.

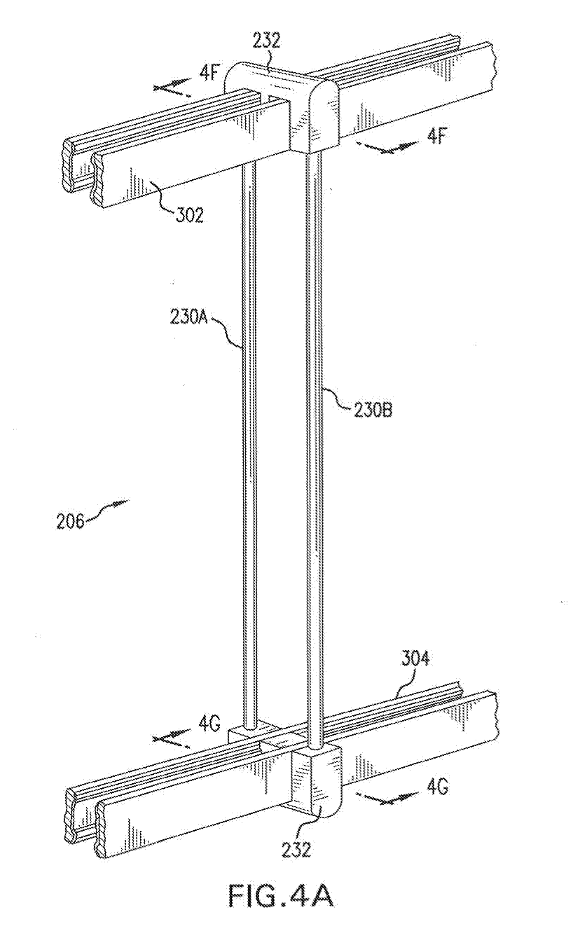

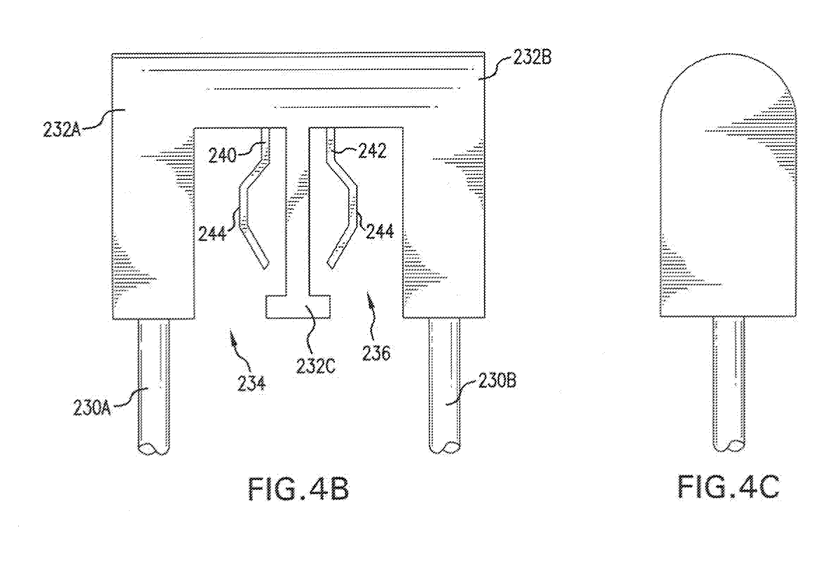

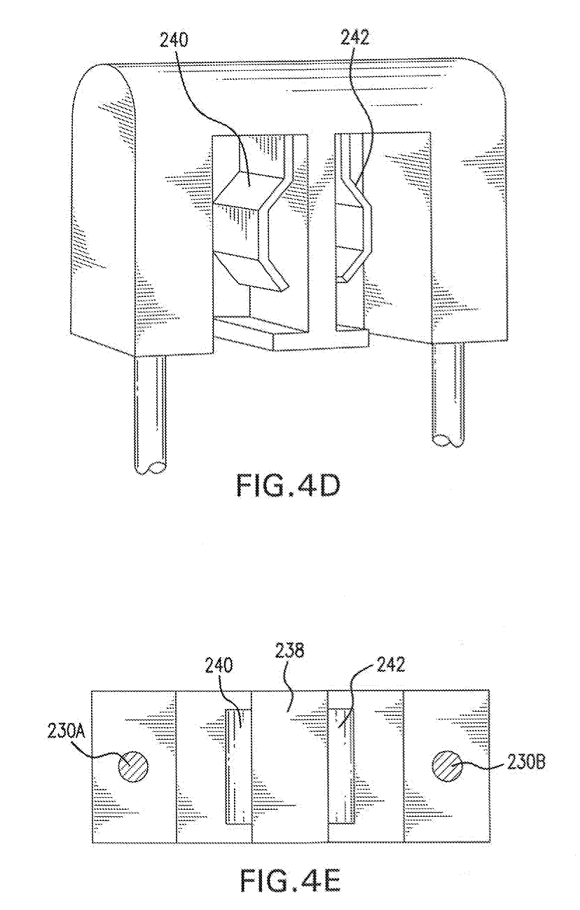

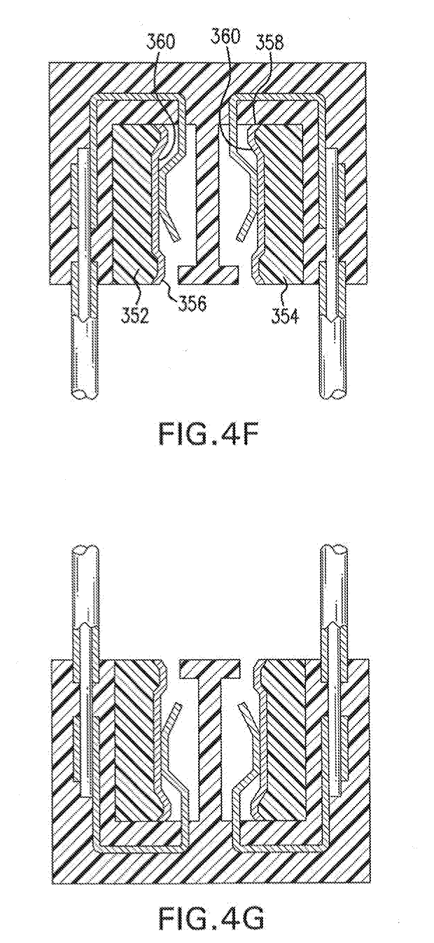

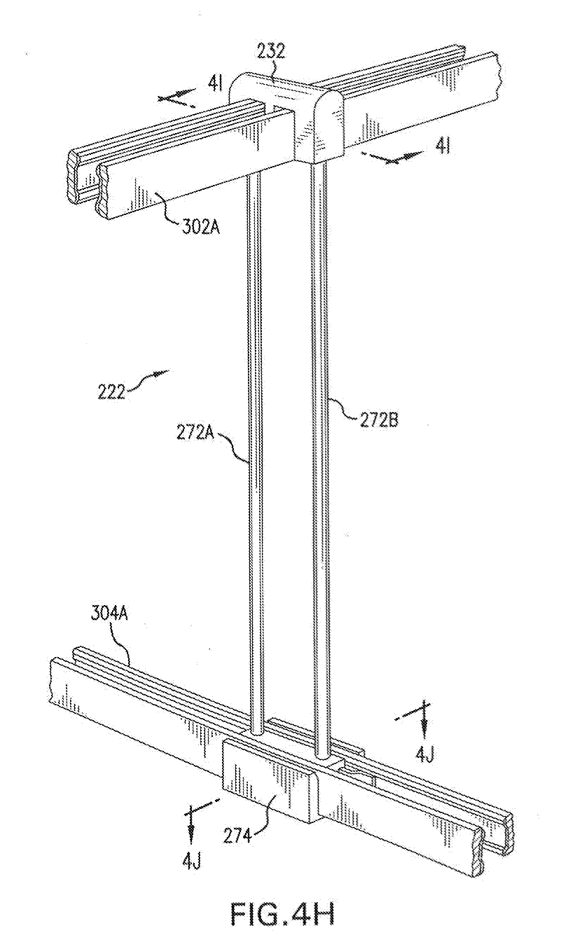

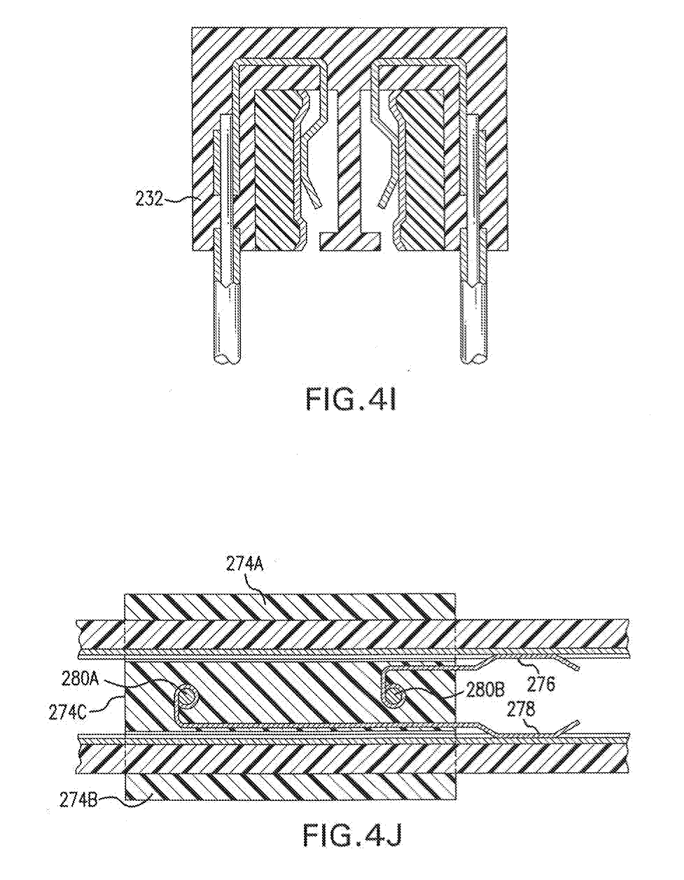

FIGS. 4A-4G show details of parallel bar hanger such as hanger 206 supporting bar 304 from bar 302 in FIG. 1. The hanger 206 includes two vertical segments 230A, 230B. At the top and the bottom, the two segments 230A, 230B have their ends imbedded in identical W-shaped bases 232, shown in more detail in FIGS. 9B-9E. The base 232 forms two channels 234, 236 with a wall 238 separating the two channels. The base 232 is further formed with two metallic springs or clips 240, 242. Clip 240 is electrically attached to segment 230A within the base 232, and clip 242 is connected to segment 230B. Preferably, base 232 is made of a non-conductive material and is over molded to cover portions of the clips 240, 242 and segments 230A. 230B. In one embodiment, the two bases 232 have a single, unitary structure. In another embodiment, at least the top base is made of two sections 232A, 232B that snap together along line 232 forming an interference fit therebetween.

As can be seen in FIGS. 4F and 4G, the bases 232 as sized and shaped so that they fit over and engage the bars 302, 304. Importantly, the clips 240, 242 are sized and shaped so that they engage the rails 356, 358. The clips 240, 242 have a flat section 244 sized and shaped to snap into the channels 356, 358 of the bars 302, 304. In this manner not only do the clips 240, 242 provide a solid electrical contact with the rails 356, 358 but they also stabilize the hangers on the bars and insure that the lower bar 304 remains stiff and does move around in use. The clips may be made from beryllium copper.

Hanger 208 has a similar configuration however the clips need not be connected electrically to the hanger segments. In other cases, for example, in the configuration shown in FIG. 2, hangers 222 do provide electrical connection to bars 304A and 306.

The hanger segments 230A, 230E are provided in various lengths as required to obtain the various systems described above, and they are preferably made in the shape of rods of a stiff but somewhat springy material having shape memory such as a phosphor/bronze alloy. Preferably except where an electrical contact is required, the rods are covered or painted with a thin electrically insulating material.

The hangers can be installed by separating the two segments 230A, 230B, passing the ends of the respective bars 302, 304 . . . between the segments, then lowering or raising the bars toward the respective bases 232 and then snapping the bases onto the bars into the configurations shown in FIGS. 4F and 4G.

As discussed above, and illustrated in more detail below, in some instances, the power bars extend perpendicularly to each other. For example, in FIG. 2, bars 302 and 304 are perpendicular to each other. These bars are interconnected using a hanger 222 shown in FIGS. 4H-4J. This hanger 222 has two segments 272A, 272B and a base 232 similar to the base 232 in FIGS. 9A-9G. However, at the bottom hanger 222 is provided with a different base 274. This base 274 is formed with two side wings 274A, 274B and a center wall 2740. Clips 276, 278 are provided on the center wall 274C and are connected electrically with segments 272A, 272B, respectively as show in FIG. 4J. The center wall 274C is made with two holes 280A, 280B with the lower ends of segments 272A, 272B extending into the holes and being secured to the base 222. The base 270 is sized and shaped to engage and support the power bar segments 304A, 304B of a bar 304A with the segments 272A, 272B providing power to these power bar segments. The base 232 engages the segments of the bar 302 in the manner discussed above.

In the embodiments of FIGS. 1-4J pendants are attached to power bars through hangers. In the present invention, several different lights are connected directly to a power bar and no hangers are required.

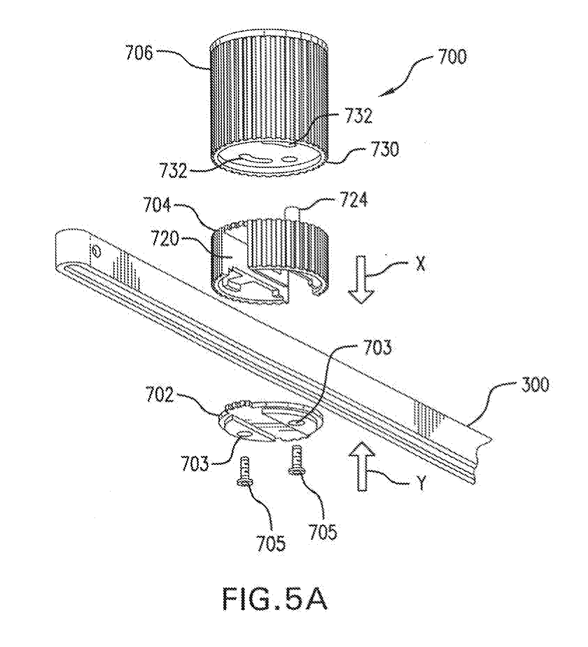

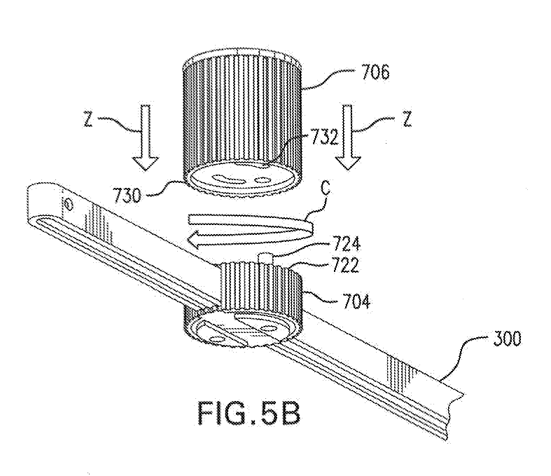

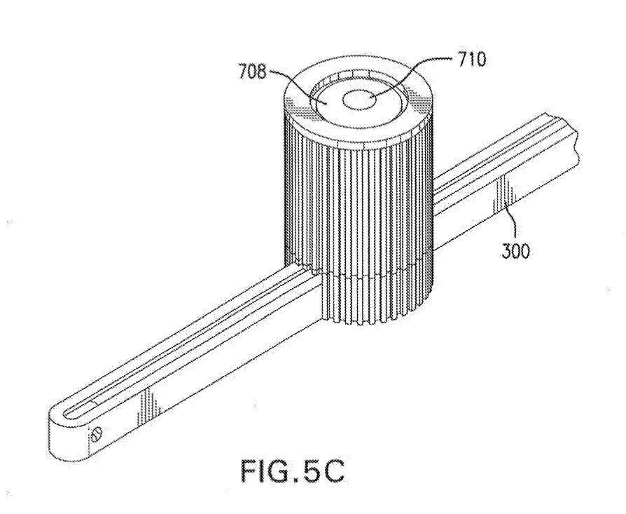

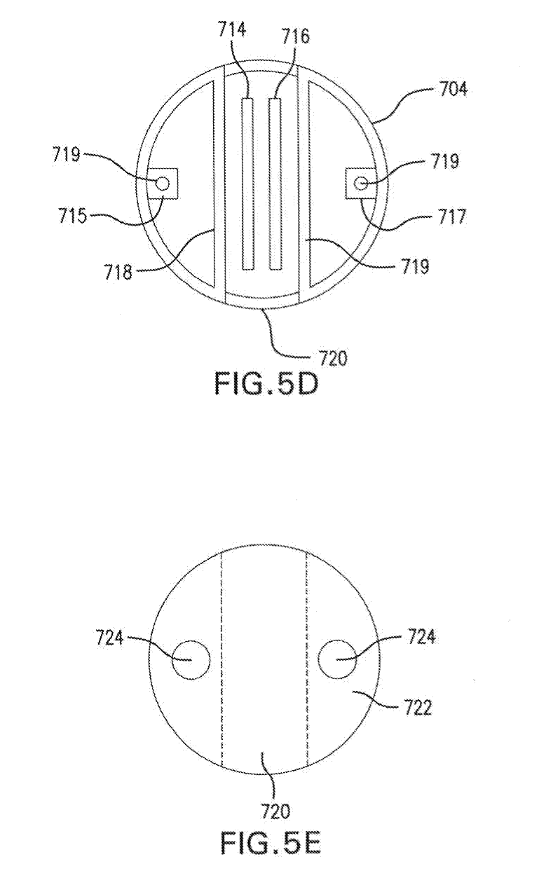

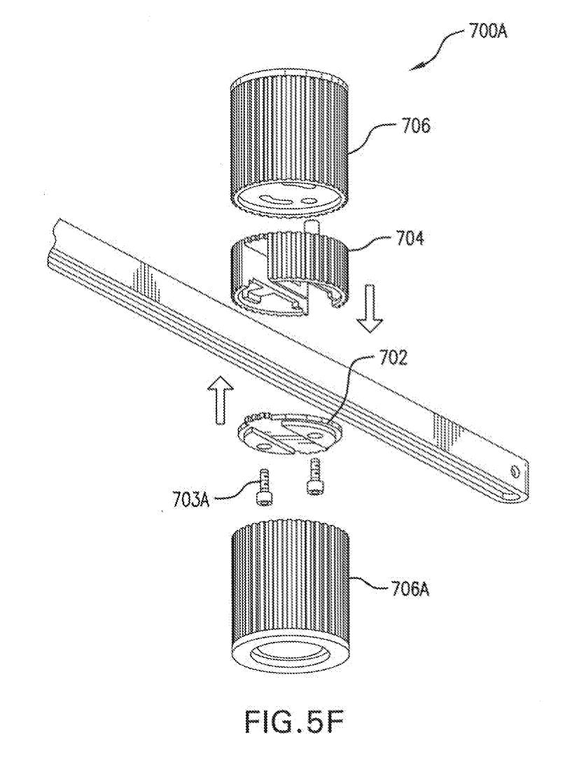

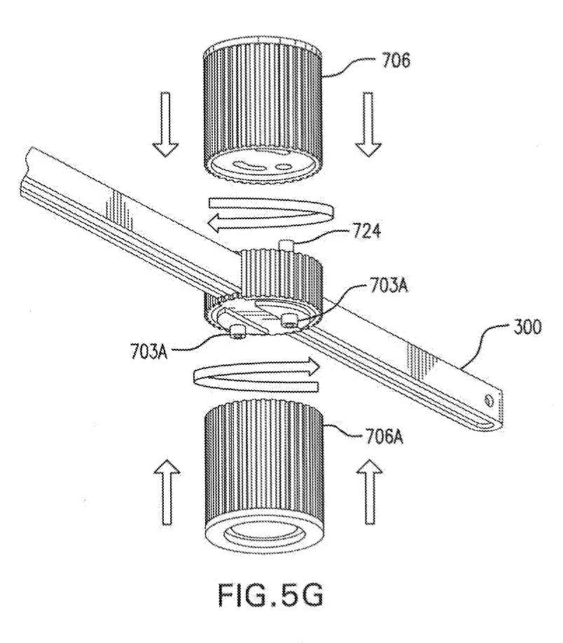

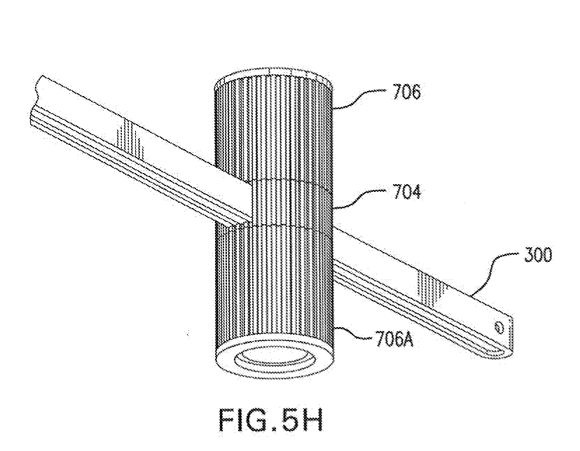

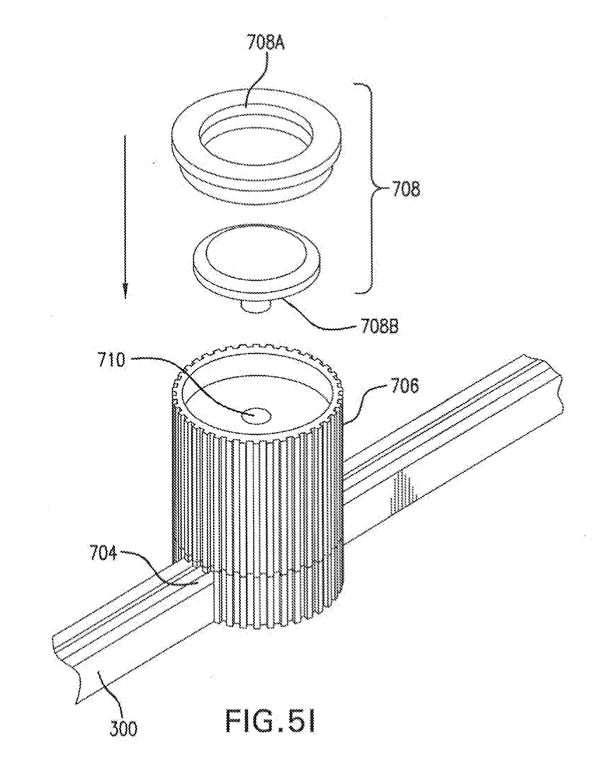

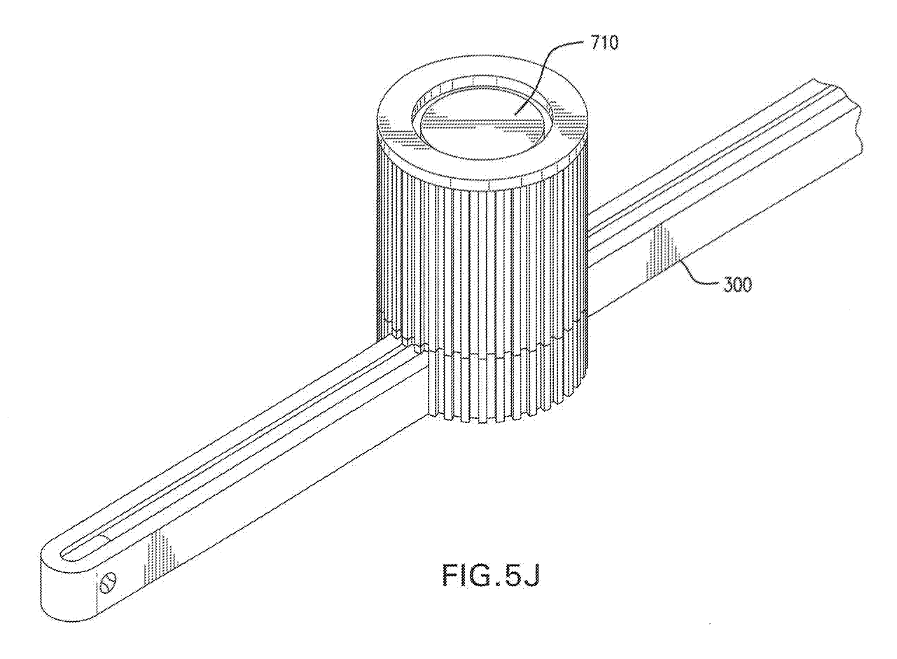

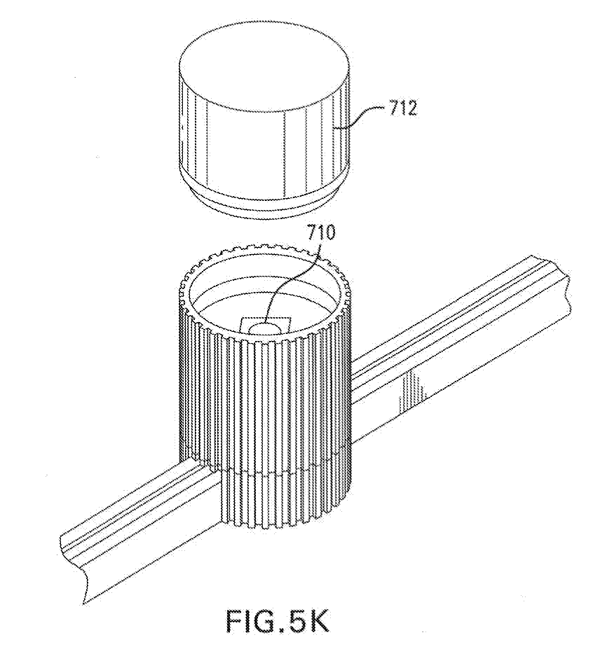

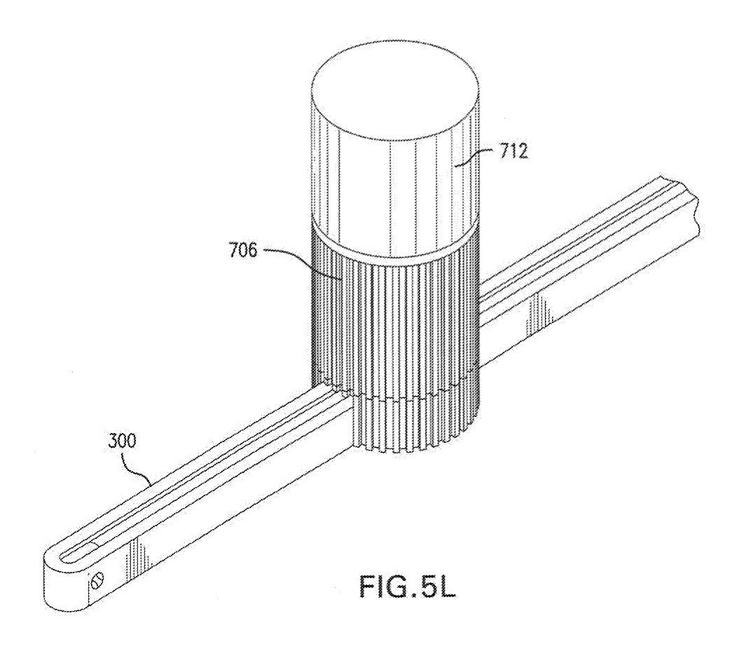

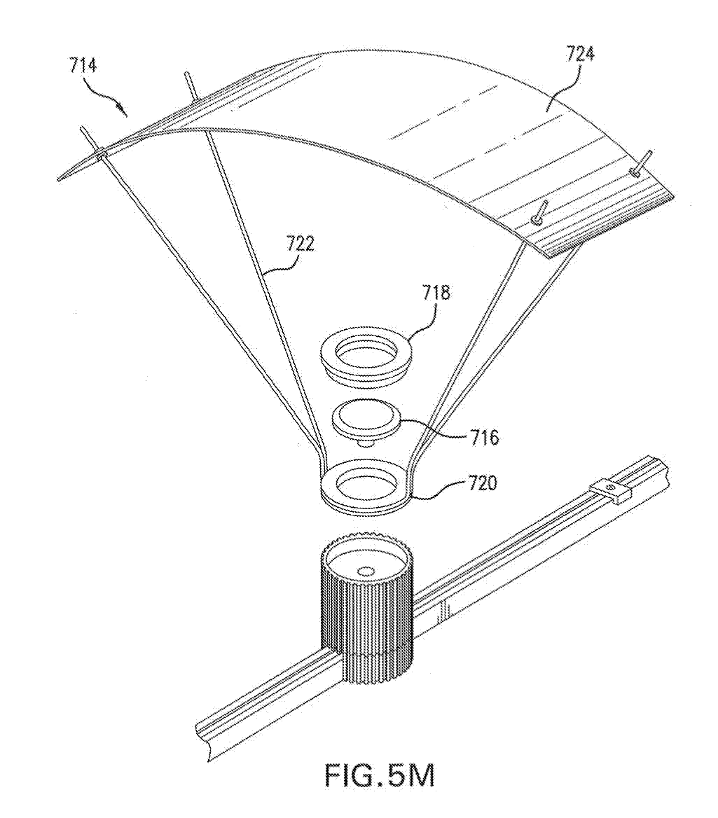

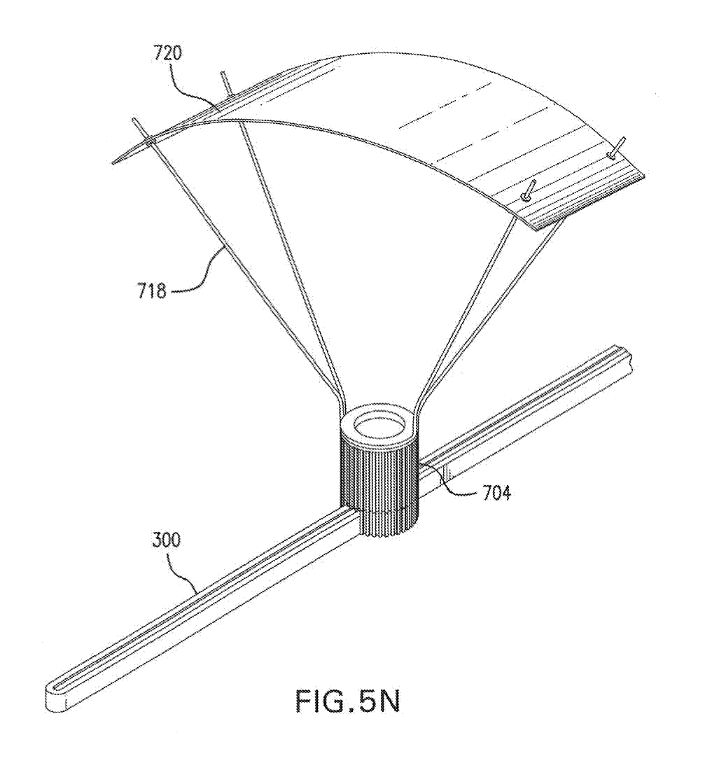

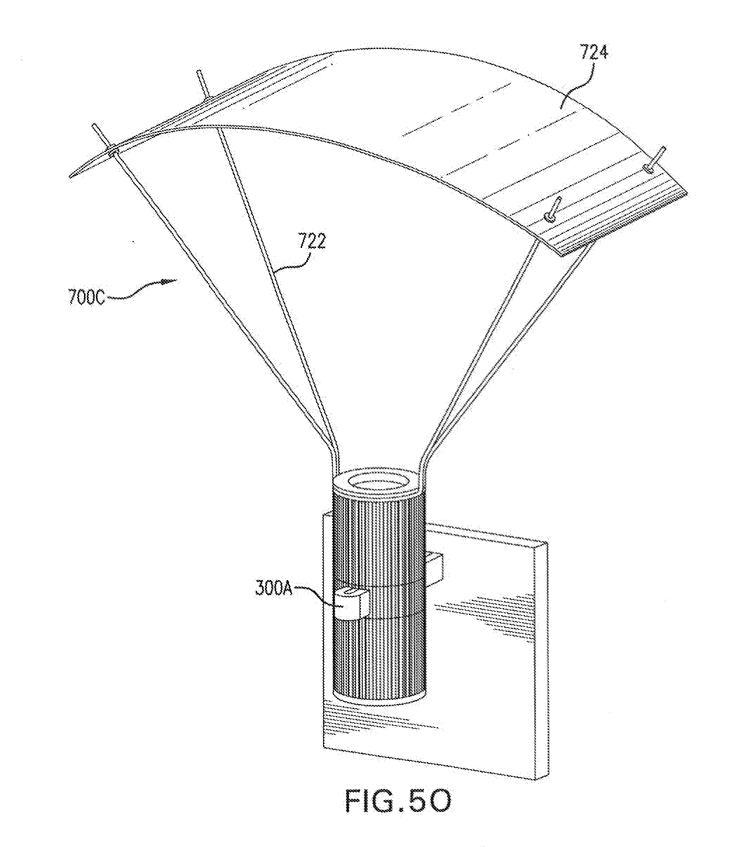

FIGS. 5A-5E show details of a spot light 700 attached to a standard power bar 300. The spot light 700 includes a cap 702, a center hub 704 and a spot head 706. The spot head is formed with a flat top surface 708 which may be transparent or translucent and covering a light source such as an LED 710.

The center hub 704 and cap 702 together form a housing that can be used to mount spot heads or other kinds of lights as discussed below. The hub 704 is formed with a channel 720. Inside the channel 720 clips 714, 716 are provided similar to the clips on the connectors 200 so that when the hub 704 is snapped onto the bar 300 with the bar 300 fitting snugly into channel 720, the clips 714, 716 form an interference fit with the bar rails 360. The hub 704 can be solid or can be hollow with two internal walls 718, 719 defining the channel 720. Two tabs 715, 717 with respective threaded holes 719 may be provided for the hub 704 as shown.

The cap 702 may have a disc shape with a diameter equal to the diameter of the hub 704 and it is shaped to cover the channel 720. Cap 702 is formed with two countersunk holes 703 and is attached to the hub 704 by two screws 705 threaded into holes 719.

The hub 704 further includes on its top surface 722 two bayonet-type pins 724. The spot head 706 is formed with a bottom surface 730 having two arcuate openings 732. The openings 732 are sized and shaped to receive pins 724.

Typically, the hub 704 is first snapped onto bus 300 (arrow X) and the cover 702 is then attached to the hub 704 (arrow Y) with screws 705. Next, the spot head 706 is mounted on the hub 704 by lowering the head 704 (arrow Z) until the pins 724 enter the openings 732 and then twisting the head in the direction C thereby engaging the head 706 to hub 704. Power to the head 706 is provided through the pins 724. Pins 724 are connected by hidden internal connectors within the central hub 704 to the clips 714, 716 and hence to the rails 360 of bar 300.

In FIGS. 5A-5C, the spot light 700 is mounted on the bar 300 so that the LED 710 is pointed upward. Alternatively, the spot light 700 can be turned around so that its LED 710 is pointing downward.

FIGS. 5F-5H show orthogonal views of a double headed spot light 700A. This spot light 700A includes an additional spot head 706A identical to head 706. For this double headed configuration, the cap 702 is reversed and threaded pins 703A are used to attach the cap 702 to the hub 704 as seen in FIG. 5F. The heads 706, 706A are then attached to the pins 724, 703A by twisting them in opposite directions, as seen in FIG. 5G. The final assembled and mounted spot light 700A is shown in FIG. 5H.

The hub 704 and the spot head 706 can be used for various kinds of pendants by adding suitable accessories. In FIGS. 51, 5J, a transparent cover 708 is used with a lens 708A mounted by a ring 708B. The lens 708A is positioned to disperse or focus light from the LED 710 as desired.

In FIGS. 5K and 5L a cylindrical diffuser 712 is used instead of cover 708.

In FIGS. 5M, 5N a parachute shaped pendant 714 is used. Pendant 714 includes a lens 716 mounted on ring 718. The ring 718 attaches to the head 706 (by a threaded engagement or other conventional means). A support member 720 is also attached to the head 706 and is connected to four or more wires 722. The wires 722 hold a translucent sheet 724.

FIG. 5O shows the pendant 714 mounted on a wall via a short power bar 300A to form a sconce.

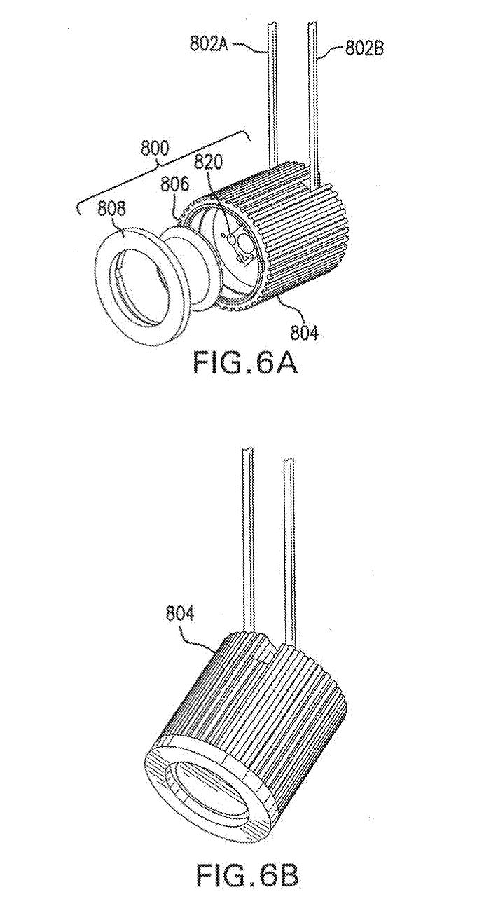

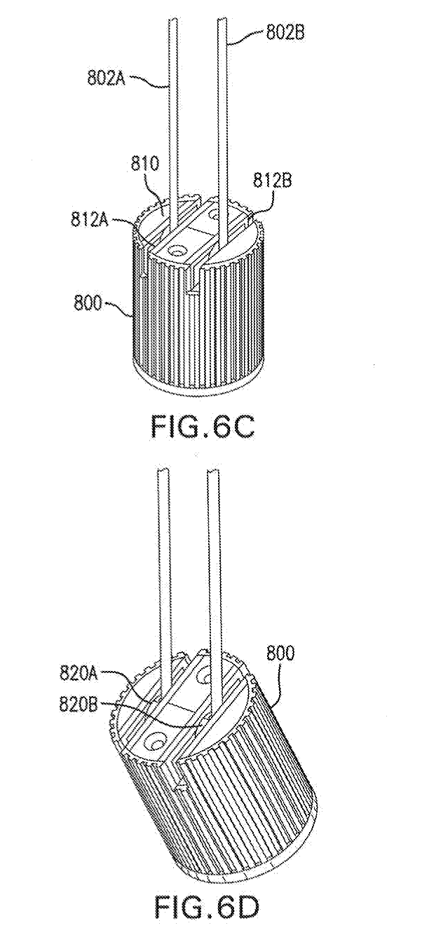

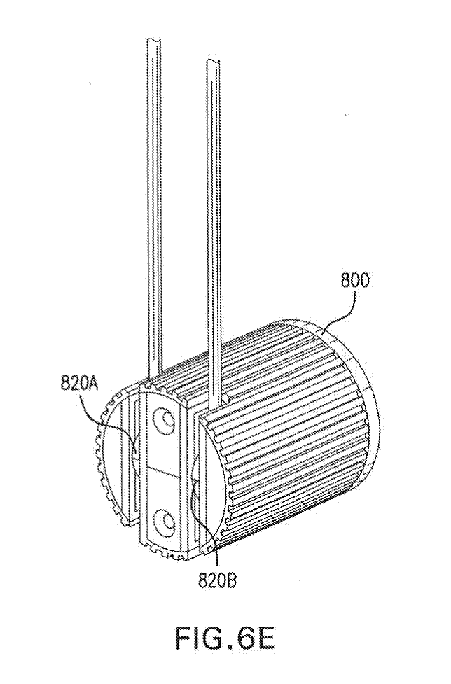

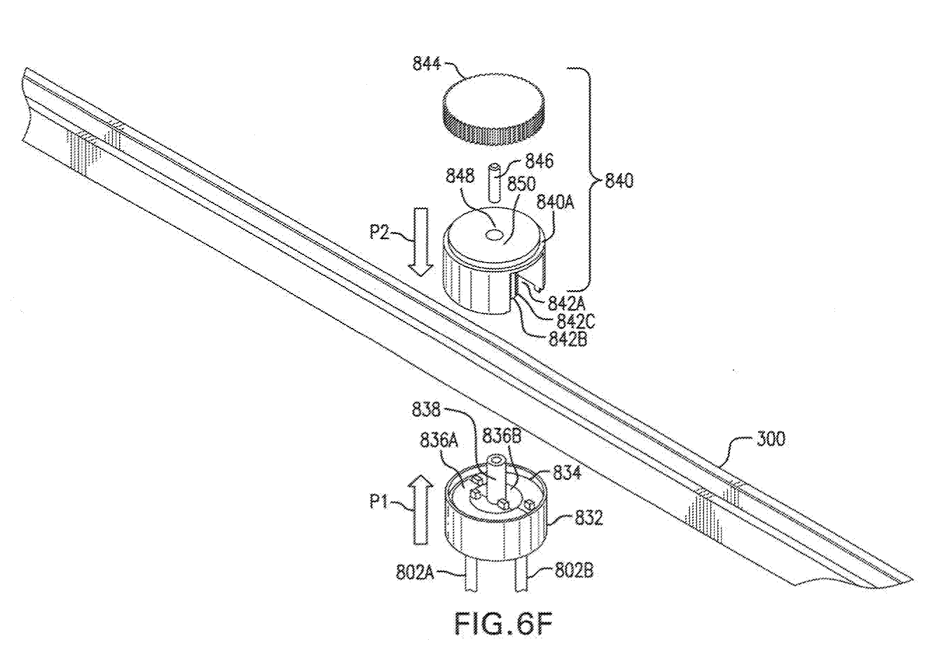

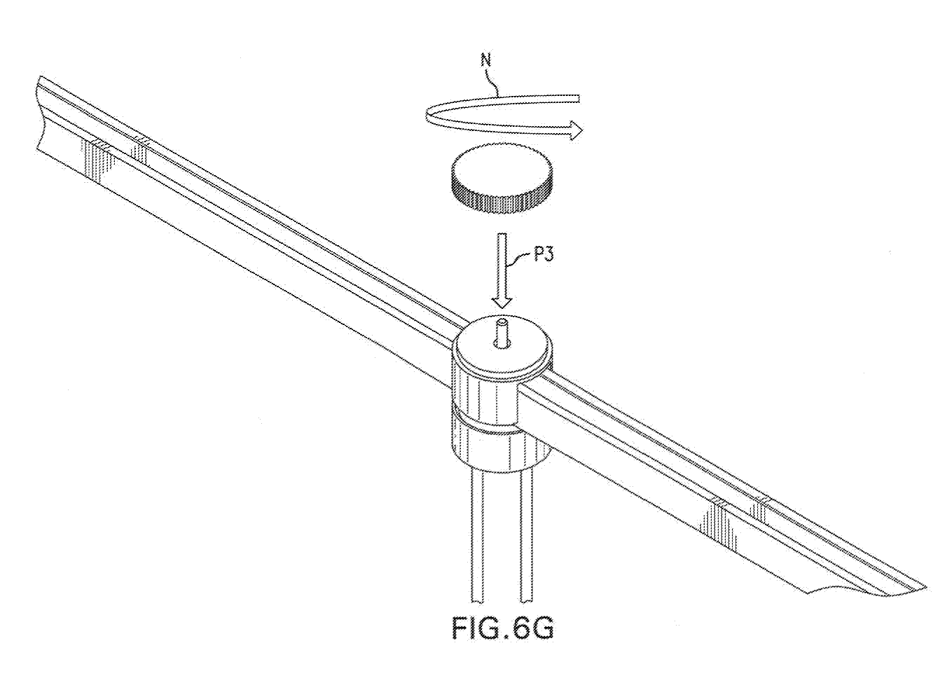

FIGS. 6A-6I show details of a directional spot pendant 800. The pendant 800 is supported by two rods 802A, 802B. Pendant 800 includes a cylindrical housing 804, a lens (or a diffuser) 806 and a mounting ring 808. The housing 804 has a top circular surface 810 with two parallel channels 812A, 812B. Disposed within each channel 812A, 812B are two semicircular connectors 820A, 820B. These connectors 820A. 820B have two orifices (not shown) receiving the lower ends of the rods 802A, 802B respectively. The connectors 820A, 820B are rotatable about a horizontal axis allowing the housing 804 to rotate by up to 180° as seen in FIGS. 6A-6E. The connectors are also adapted to provide an electric current path from the rods 802A, 802B to a power circuit disposed inside the housing 804 and driving one or more LEDs 828 or other light sources within the housing 804.

Referring now to FIGS. 8F-8G, in one embodiment, a mounting member 830 is provided for selectively rotating two vertical rods, such as the rods 802A, 802B, about a vertical axis while being mounted on a power bar 300. The member 830 includes a lower housing 832. The housing 832 includes a top surface 834 with two arcuate conducting surfaces 836A, 836B, each being electrically connected to the rods 802A, 802B respectively. Rising vertically above the surface 834 is a hollow haft 838.

Member 830 further includes an upper portion 840, similar to member 704 in FIG. 5A having two horizontal channels 842A, 842B separated by a central wall 8420, and a disk portion 844. An axle 846 fits through a hole 848 in intermediate surface 850 and is mechanically fixed to the disk portion 844. The lower and upper portions 832 and 840 can be snapped together by pushing them toward each other, as indicated by arrows P1, P2. An interference fit is formed between these two portions with the bar 300 being disposed in channels 842A, 842B and the center wall 8420 engaging the rails of the bar 300. In this position, electrical clips on wall 8420 (not shown) connect the conducting surfaces 836A, 836B with the rails within the bar 300. As the disk 844 is snapped onto the section 840A and disk 844 is pushed downward in direction P3, its axle 846 passes through the hole 848 and engages the shaft 838. Therefore, when the disk 844 is rotated about its vertical axis X-X defined by axle 846 and shaft 838, this motion is transmitted to the rods 802A, 802B thereby rotating them as indicated by arrow N. In other words, rotating the disk 844 causes the rods 802,802B by up to 180°. A pendant attached to the rods 802A, 802B is rotated as well.

Going back to FIG. 60, if the pendant 800 is attached to rods 802A, 802B that can be rotated about a vertical axis as just described, then the pendant 800 can be rotated not only about a horizontal axis but also a vertical axis and, so it can be positioned to point at any downward direction. An interference fit is provided for both the connectors 820A, 820B and within member 830 so that once the pendant is positioned to point at any particular direction, it will be maintained in that position by the frictional forces from these interference fits.

Numerous modifications may be made to this invention without departing from its scope as defined in the appended claims.

What is claimed is:

1. In a modular lighting system having a power bar receiving power from a power source, the power bar having two horizontally spaced segments with rails connected to a power source, a pendant comprising:
a bar engaging member having two horizontal channels with a separating wall sized and shaped to engage the power bar with the two segments disposed in said channels, said bar engaging member further including electrical clips arranged to form an interference fit and an electrical connection with the rails within the power bar, said bar engaging member further including a first flat surface; and;
a first pendant body attached to said first flat surface and a light source receiving power through said electrical clips and generating light.

2. The pendant of claim 1 wherein said first flat surface is formed with two pins and said first pendant body is formed with two openings, said first pendant body being attached by coupling said first pendant body and said bar engaging member with said pins entering said openings and twisting said pendant body and said bar engaging member with respect to each other.

3. The pendant of claim 2 wherein said pins provide electrical current to said light source.

4. The pendant of claim 1 wherein said bar engaging member and said first pendant body have matching cross-sections.

5. The pendant of claim 4 wherein said bar engaging member and said first pendant body are cylindrical.

6. The pendant of claim 1 further comprising a second pendant body substantially identical to said first pendant body.

7. The pendant of claim 6 wherein said bar engaging member includes a second flat surface spaced from and substantially identical with said first flat surface, said second body being attached to said second flat surface.

8. The pendant of claim 1 further comprising covering said channels.

9. In a modular lighting system having a power bar receiving power from a power source, the power bar having two horizontally spaced segments with rails connected to a power source, and a hanger having a power bar engaging member selectively engaging the power bar and two vertical rods, each rod being electrically connected to a respective rail, a pendant comprising:
a pendant body having first and second connectors, each said connector being configured to receive a respective end of one of said vertical rods, a light source disposed in said pendant body and generating light when receiving current from the power bar through the rods and said connectors, said connectors being arranged and constructed to rotate within said pendant body to allow said pendant body to rotate about a horizontal axis with respect to the rods while remaining connected to the rods.

10. The pendant of claim 9 wherein said pendant body includes a top surface with two parallel channels, said connectors being disposed in said channels.

11. The pendant of claim 10 wherein said channels are sized and positioned to receive a portion of the rods when said pendant body is disposed at an angle of about plus or minus 90°.

12. In a modular lighting system having a power bar receiving power from a power source, the power bar having two horizontally spaced segments with rails connected to a power source, a pendant comprising:
a hanger having a power bar engaging member selectively engaging the power bar and two vertical rods, each rod being electrically connected to a respective rail of the power bar; and
a pendant body having first and second connectors, each said connector being configured to receive a respective end of one of said vertical rods, a light source disposed in said pendant body and generating light when receiving current from the power bar through the rods and said connectors, said connectors being arranged and constructed to rotate within said pendant body to allow said pendant body to rotate about a horizontal axis with respect to the rods while remaining connected to the rods.

13. The pendant of claim 12 wherein said power bar engaging member is configured to allow said rods to rotate about a vertical axis with respect to the power bar.

14. The pendant of claim 13 wherein said power bar engaging member is formed with two horizontal channels with a separating wall sized and shaped to engage the power bar with the two segments disposed in said channels, said bar engaging member further including electrical clips arranged to form an interference fit and an electrical connection with the rails with the power bar; said rods being electrically connected to the rails of the power bar through said clips.

15. The pendant of claim 14 wherein said hanger includes a lower body selectively attached to said power bar engaging member with the power bar disposed within said channels, said rods depending on said lower body.
